(19) United States
(12) Patent Application Publication
(10) Pub. No.: US 2013/0179600 A1
(43) Pub. Date: Jul. 11, 2013

(54) DEVICE MANAGER AND DEVICE MANAGING METHOD

(71) Applicant: Azbil Corporation, Tokyo (JP)

(72) Inventor: Toshihisa Fujii, Tokyo (JP)

(73) Assignee: AZBIL CORPORATION, Tokyo (JP)

(21) Appl. No.: 13/733,266

(22) Filed: Jan. 3, 2013

(30) Foreign Application Priority Data
Jan. 6, 2012 (JP) 2012-001222

(51) Int. Cl. G06F 9/44

(52) U.S. Cl. CPC G06F 9/4411
USPC 710/8

(57) ABSTRACT

A device manager displaying on a screen, in a tree format, icons corresponding to devices that are managed in a hierarchical structure, including a configuration information table storing, for each device, configuration information pertaining to the configuration of that device; a receiving portion receiving an alert event generated by any of the devices; an evaluating portion evaluating whether or not an address of a device matches any of the addresses stored in the configuration information table when a received alert event is an installation event; a configuration information registering portion generating, and registering into the configuration information table, configuration information based on the received alert event if the address of the device does not match any of the addresses in the configuration information table; and a displaying portion displaying the icons on the screen based on the configuration information stored in the configuration information table.

### CROSS-REFERENCE TO RELATED APPLICATION

The present application claims priority to Japanese Patent Application No. 2012-001222 filed Jan. 6, 2012. This application is incorporated herein by reference.

### FIELD OF TECHNOLOGY

The present invention relates to a device manager and a device managing method.

### BACKGROUND

In a work area wherein production processes are managed, large numbers of devices (for example, sensor devices and devices such as valve positioners) are located throughout the plant in order to manage the processes. The various devices within the plant are typically connected in a hierarchical structure. Consequently, in a system for managing devices the devices are displayed in a manage screen in a tree format matching that hierarchical structure, to enable the large number of devices, which exist in a complex arrangement, to be understood easily. Japanese Unexamined Patent Application Publication 2005-346444 (“JP '444”) discloses a manage system for displaying, using icons, alert statuses that are produced by the individual devices, with the devices displayed in a tree format.

In the management system in JP '444, information for various devices that is displayed on a screen in a tree format is managed centrally by a manager. In other words, when a new device is added to the system, information for that device must be registered in the managing device or else the added device is not be displayed on the screen. On the other hand, information regarding the hierarchical structure is also included in the information for the device, and thus, when registering the device, it is necessary to understand the hierarchical information, and the like, for that device in advance. Consequently, when this work of registration arises each time a device is added, this increases the workload on the administrator.

The present invention was created in order to solve the aforementioned problem area in the conventional technology, and the object thereof is to provide a device manager and device managing method wherein a device that is added to the system can be displayed on the screen easily.

### SUMMARY

A device manager according to the present invention is a device manager displaying on a screen, in a tree format, respective indicators corresponding to a plurality of devices managed in a hierarchical structure, including a storing portion for storing, for each device, configuration information pertaining to the configuration of that device; a receiving portion for receiving an alert event produced by one of the devices; an evaluating portion for evaluating whether or not an address of a device matches any of the addresses included in the configuration information that is stored in the storing portion if the alert event received by the receiving portion is an installation event that is generated when a device is connected to the system; a configuration information registering portion for generating, and storing into the storing portion, configuration information based on the alert event received by the receiving portion if the conclusion by the evaluating portion is that the address of the device does not match any of the addresses included in the configuration information; and a displaying portion for displaying said indicators on said screen based on the configuration information stored in the storing portion.

A device managing method for displaying on a screen, in a tree format, respective indicators corresponding to a plurality of devices managed in a hierarchical structure, including a receiving step for receiving an alert event produced by one of the devices; an evaluating step for evaluating whether or not an address of a device matches any of the addresses included in the configuration information that is stored in a storing portion, which stores, for each of the devices, configuration information pertaining to the configuration of that device, if the alert event received in the receiving step is an installation event that is generated when a device is connected to the system; a configuration information registering step for generating, and storing into the storing portion, configuration information based on the alert event received in the receiving step if the conclusion is the evaluating step is that the address of the device does not match any of the addresses included in the configuration information; and a displaying step for displaying said indicators on said screen based on the configuration information registered in the storing portion.

Given these structures, if there is a case wherein an installation event that occurs when a device is connected to the system is received and there is some sort of mismatch between the address of that device and an address that is included in the configuration information, it is possible to generate the configuration information for that device and register it in the storing portion, making it possible to display, based on the configuration information after registration, indicators corresponding to a plurality of devices are connected to the system, doing so in a tree format on the screen. Because of this, even when a device connection is added to the system, an indicator corresponding to that device can be displayed on the screen with ease.

A registration instruction requesting portion for requesting the inputting of an instruction as to whether or not to register a device corresponding to the alert event when there is a conclusion by the evaluating portion that there is some type of mismatch between the address of the device and an address included in the configuration information may further be provided, and the configuration information registering portion may generate configuration information and store it in the storing portion when, in response to the request by the registration instruction requesting portion, an instruction is received indicating that the device is to be registered.

Doing so makes it possible to register configuration information for a device that is newly connected only when registration is approved by the administrator, thus making it possible to prevent situations such as wherein configuration information is registered for a device that is connected in error, for example.

The configuration information registering portion, when generating the configuration information, may obtain, from the device, information that does not exist in the alert event.

Doing so makes it possible to reduce the work by the administrator in inputting supplemental information that does not exist in the alert events.

The present invention makes it possible to provide a device manager and device managing method wherein a device that is added to the system can be displayed on the screen easily.

### BRIEF DESCRIPTIONS OF THE DRAWINGS

FIG. 1 is a diagram illustrating a structure for a device managing system including a device manager according to an example.

FIG. 2 is a diagram illustrating a data structure for the structural information table shown in FIG. 1.

FIG. 3 is a diagram illustrating a data structure for the event history information table shown in FIG. 1.

FIG. 4 is a diagram illustrating one example of icons that are displayed in a tree format on the screen.

FIG. 5 is a flowchart for explaining the operation of a device manager according to another example.

### DETAILED DESCRIPTION

An example according to the present invention is explained below in reference to the drawings. However, the example explained below is no more than an illustration, and does not exclude various modifications and applications to technologies not explicated below. That is, the present invention can be embodied in a variety of modified forms, in the scope that does not deviate from the spirit and intent thereof.

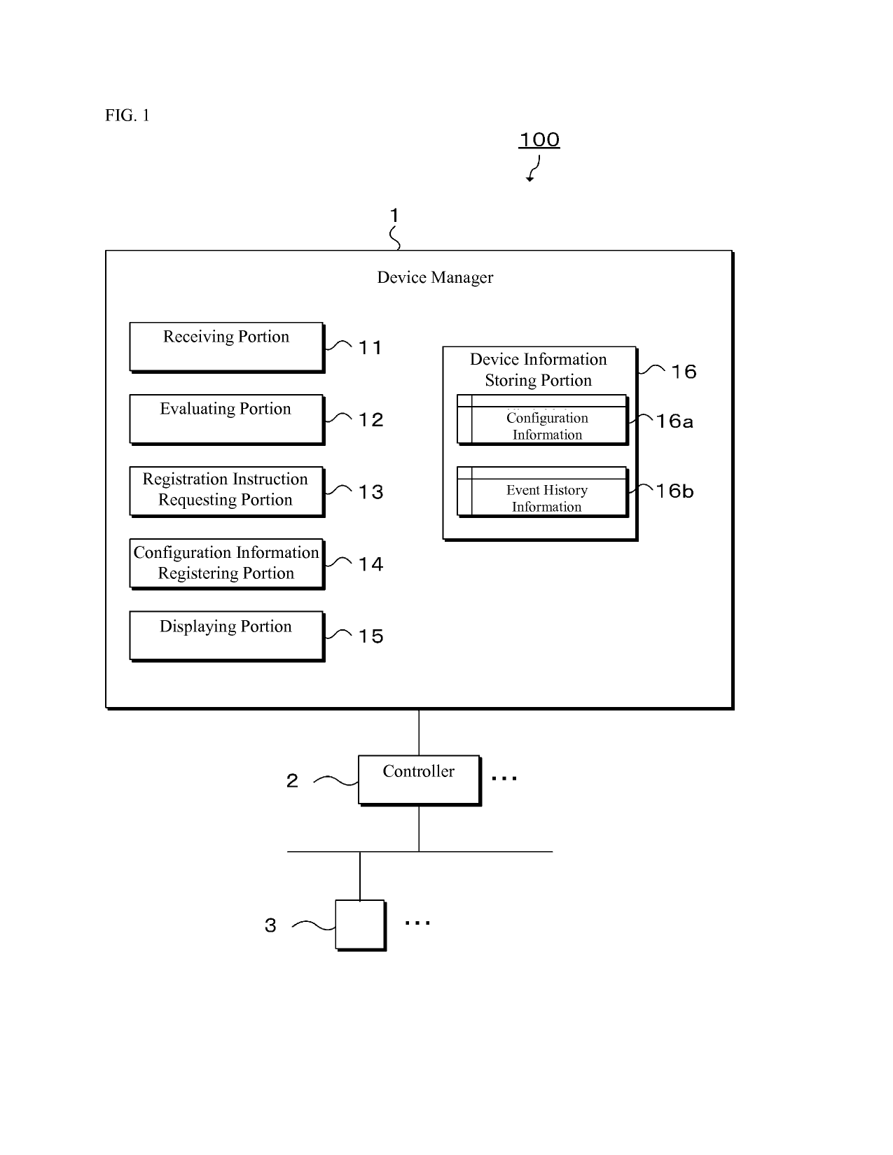

FIG. 1 is a diagram illustrating a schematic structure for a device managing system that includes a device manager according to an example according to the present invention. As illustrated in FIG. 1, the device managing system 100 comprises a device manager 1, one or more controllers 2, and one or more devices 3. The controller 2 and the device 3 are “devices” in a hierarchical relationship, where the controller 2 is located on a higher hierarchical level and the device 3 is located hierarchically below the controller 2.

The device 3 is a device that is disposed within a plant, and has a function for two-way communication with the controller 2 through, for example, a fieldbus. A “fieldbus” is a network with a communication protocol enabling two-way communication through digital signals, where the communication specifications have been standardized as the “Foundation Fieldbus” by the Fieldbus Foundation®.

The device 3 may be one of a variety of sensor devices for detecting, for example, flow rates, pressures, temperatures, or the like, or one of a variety of actuators for operating a fan, a pump, or a valve positioner for managing any of a variety of valves such as a flow rate managing valve, a pressure managing valve, or the like.

The controller 2 is a device for the overall management of the device 3 that is positioned hierarchically thereunder. The controller 2 controls the valve positioner based on, for example, a measured value for a flow rate or pressure, from the sensor device, to adjust the degree of opening, or the like, of a valve that is disposed within a pipe.

The device manager 1 is a device for managing device information of controllers 2 and devices 3. The device manager 1 physically comprises, for example, a managing device (not shown) such as, for example, a CPU (Central Processing Unit), a storage device (not shown) such as a memory or an HDD (Hard Disk Drive), an inputting device (not shown), and a displaying device (not shown). The storage device is provided with, for example, a configuration information table 16a and an event history information table 16b has various types of tables for storing device information.

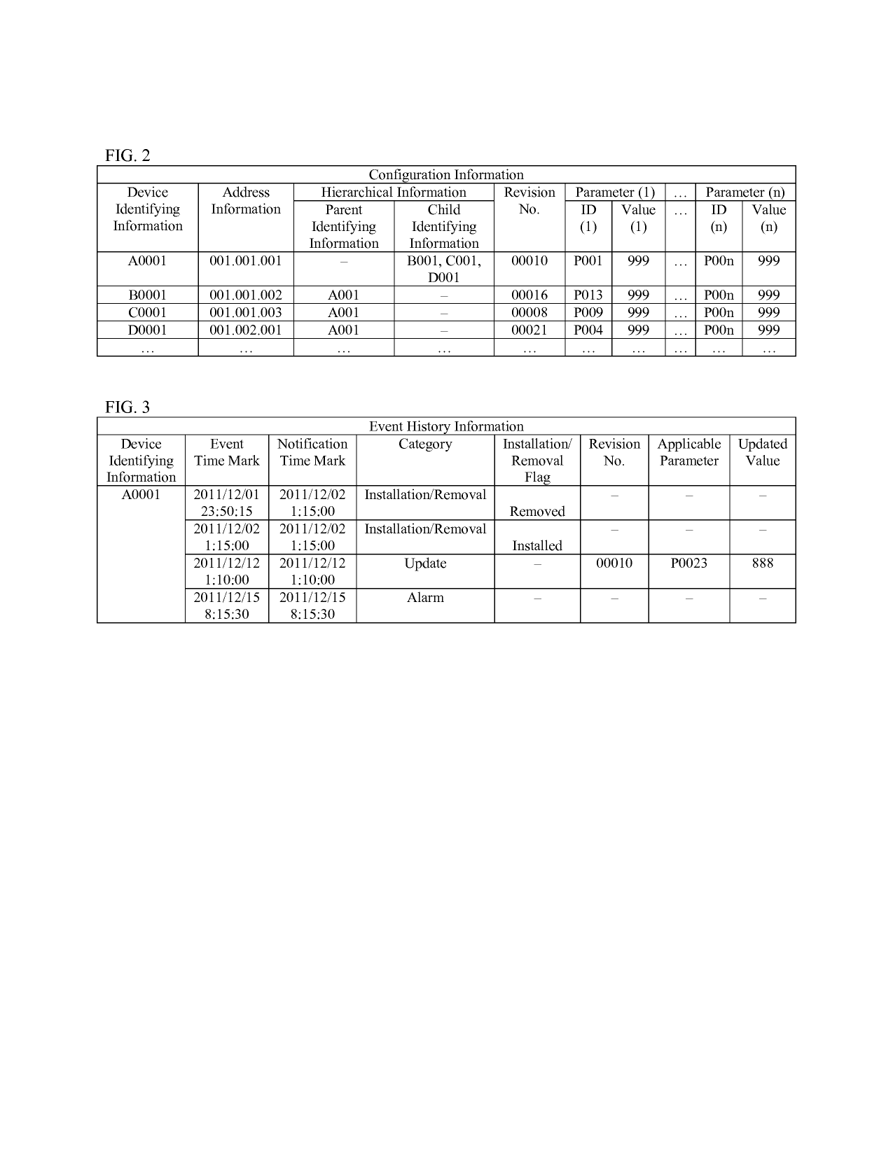

The configuration information table 16a is a storing portion for storing configuration information regarding the configurations of the controllers 2 and the devices 3. The data structure of the configuration information table 16a is explained in reference to FIG. 2. The configuration information table 16a has, for example, a Device Identifying Information field, an Address Information field, a Hierarchical Information field, a Revision No. field, and a Parameter Field as data fields.

The Device Identifying Information field stores device identifying information that specifies the controllers 2 and devices 3 uniquely. The Address Information field stores address information indicating the locations of the controllers 2 and the devices 3 within the system. The Hierarchical Information field stores device identifying information for a parent node and device identifying information for a child node having a hierarchical relationship with a given device.

The Revision No. field stores a revision number that is incremented each time there is a change in a parameter that is stored in the Parameter field. The Parameter field stores sets of a plurality of parameter information, where a parameter ID that uniquely specifies a parameter, and the parameter value thereof, constitute a single set.

The event history information table 16b is a storing portion for accumulating, as historical information, event information pertaining to alert events that are produced by the controllers 2 and the devices 3. The data structure of the event history information table 16b is explained in reference to FIG. 3. The event history information table 16b has, for example, a device Identifying Information field, an Event Time Mark field, a Notification Time Mark field, a Category field, an Installation/Removal Flag field, a Revision field, an Applicable Parameter field, and an Updated Value field, for example, as data fields.

The Device Identifying Information field stores device identifying information that specifies the controllers 2 and devices 3 uniquely. The Event Time Mark field stores an event time mark that is the time at which an alert event has been produced by a controller 2 or a device 3. The Notification Time Mark field stores a notification time mark that is a time mark for the time at which there was the notification for the alert event produced by the controller 2 or the device 3. The provision of the notification time mark in addition to the event time mark is in consideration of a controller 2 or a device 3 being cut off from the system. If the controller 2 or the device 3 is cut off from the system, then it is not possible to provide notification even when an alert event is produced, so the notification of the alert event having been produced during the time wherein the device is cut off from the system can be after reconnection to the system. Given this, the provision of the notification time mark in addition to the event time mark is to enable manage of alert that are produced while a device is cut off from the system.

The Category field stores the categories of the alert events. As the types of alert events there are, for example, “installation/removal,” “update,” and “alarm.” “Installation/removal” indicates that the alert event is an installation or removal event that is produced when a controller 2 or a device 3 is connected or disconnected. “Update” indicates that the alert event is an update event that is produced when a parameter is updated for a controller 2 or a device 3. “Alarm” indicates that the alert event is an alarm event for providing notification of an alarm produced by a controller 2 or a device 3.

The Installation/Removal Flag field stores flag information indicating either a connection or a disconnection, and is a data field that is added when the alert event is an installation/removal event. In FIG. 3, “Installed” is stored as flag information indicating that a device is connected, and “Removed” is stored as flag information indicating disconnection. The installation/removal event wherein the flag information is “Installed” may also be termed an “installation event,” and an installation/removal event wherein the flag information is “Removed” may also be called a “removal event.”

The Revision field, the Applicable Parameter field, and the Updated Value field are data fields that are added when the alert event is an update event. The Revision field stores the post-update revision number. The Applicable Parameter field stores the parameter ID of the parameter that was subject to updating. The Updated Value field stores the post-update parameter value.

In the device managing system 100, higher-level devices collect communication status information regarding lower-level devices. The communication status information is information pertaining to the status of communication of the devices, including data communication okay/fault information. The higher-level device, based on the data communication okay/fault information that is included in the collected communication status information, evaluates the connection status of the lower-level device, to generate installation/removal event information and send it to the device manager 1.

Here if the higher-level device is disconnected, then removal events wherein the installation/removal flag field stores “Removed” can be produced as the installation/removal events corresponding to that device and to all devices located hierarchically thereunder, which are stored in the event history information table 16b. On the other hand, if the higher-level device is connected, then installation events wherein the installation/removal flag field stores “Installed” can be produced as the installation/removal events corresponding to that device and to all devices located hierarchically thereunder, which are stored in the event history information table 16b.

As illustrated in FIG. 1, the device manager 1, functionally, has, for example, a receiving portion 11, an evaluating portion 12, a registration instruction requesting portion 13, a configuration information registering portion 14, and a displaying portion 15.

The receiving portion 11 receives alert events produced by any of the devices.

The evaluating portion 12 evaluates whether or not an alert event received by the receiving portion is an installation event. If the alert event received by the receiving portion 11 is an installation event, then the evaluating portion 12 evaluates whether or not the address of the device that produced the alert event matches any of the addresses stored in the configuration information table 16a.

This makes it possible to evaluate whether or not a device connection has been added to the system through this evaluation, because, when a device connection is added to the system, an installation event is sent from that device in a form wherein configuration information includes the address of that device has not yet been registered.

If it is determined by the evaluating portion 12 that the address of the device does not match any of the addresses that are stored in the configuration information table 16a, then the registration instruction requesting portion 13 requests inputting of an instruction as to whether or not to register into the system the device that produced the alert event. This request may be a prompt to the administrator to input an instruction, and, for example, may prompt inputting through using a display of an instruction inputting screen, a display of a message, an output of an audible message, a transmission of email, or the like.

When, in response to the request by the registration instruction requesting portion 13, an instruction that is a registration approval indicating that the device is to be registered is received, the configuration information registering portion 14 generates configuration information based on the alert event that was received by the receiving portion 11, and registers that information in the configuration information table 16a. When generating the configuration information, the configuration information registering portion 14 evaluates whether or not there is incomplete information, which is information that does not exist in the alert event. If there is incomplete information, then the configuration information registering portion 14 obtains that incomplete information from the device, to generate the configuration information based on that incomplete information and on the alert event that was received by the receiving portion 11, and registers this configuration information in the configuration information table 16a.

Based on the configuration information that is stored in the configuration information table 16a at that time, the displaying portion 15 displays indicators corresponding to the various devices in a tree format on the screen. Icons, for example, may be used as the indicators. This makes it possible to display icons corresponding to the devices on the screen at the point in time that the new device has been added to the system and configuration information for that device has been registered into the configuration information table 16a.

The display format for the icon may be determined in accordance with the status of the device corresponding to that icon. Statuses of devices correspond to, for example, whether or not the device is connected to the system, the priority level of an alert event, whether or not an alert event has been acknowledged, and the like. Whether or not the device is connected can be evaluated through the installation/removal events. The priority level and whether or not an alert event has been acknowledged can be evaluated by, for example, establishing priority level information in the alert events and establishing an acknowledged/unacknowledged flag, and then referencing those.

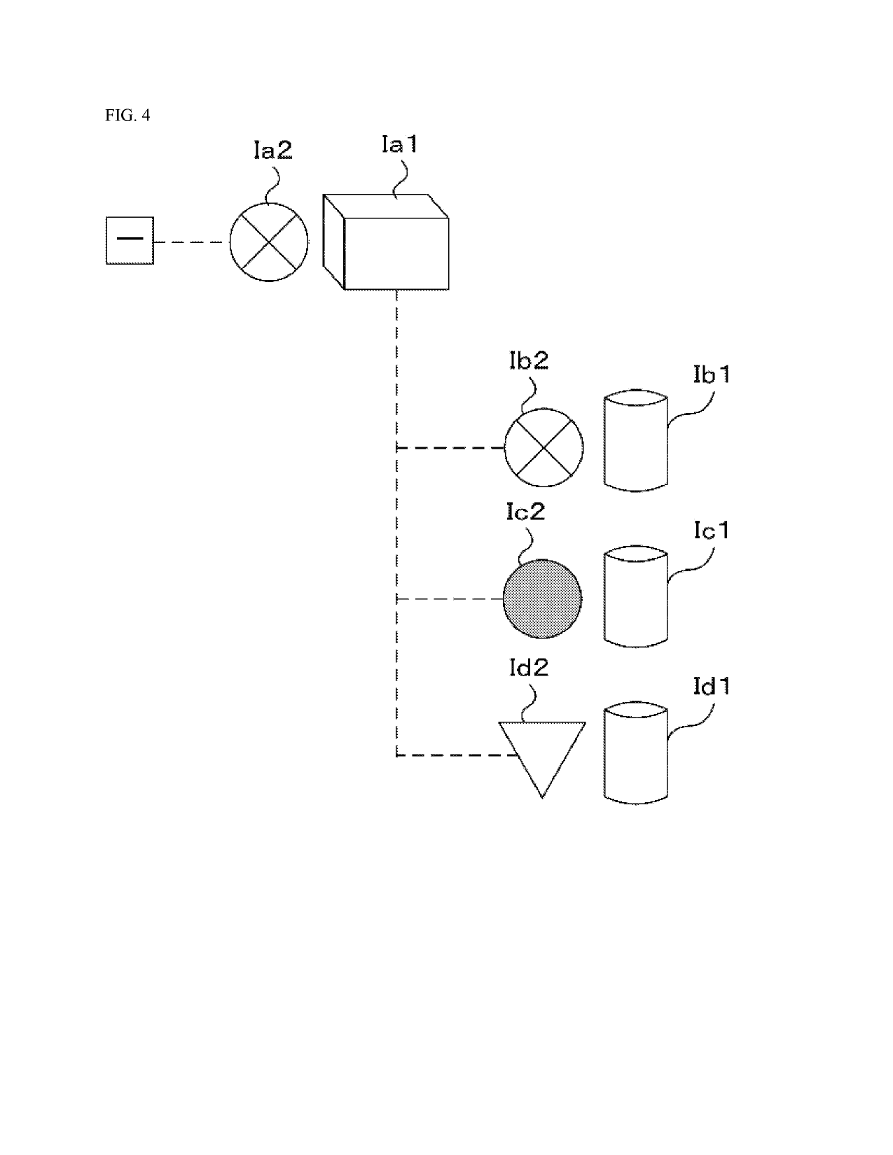

FIG. 4 shows an example of a display of icons, corresponding to devices, in a tree format on a screen. FIG. 4 is a diagram illustrating, in a tree format, a situation wherein there are three devices located below one device that is located on a higher hierarchical level.

An icon Ia1 for displaying that a device is connected to the system, and an icon Ia2 for displaying the highest priority level for that device, are displayed in an indicator displaying region for the one device that is located on the higher hierarchical level. Moreover, in the indicator displaying region for the three devices that are located on the lower hierarchical level, icons Ib1, Ic1, and Id1, which indicate that the individual devices are connected to the system, and icons Ib2, Ic2, and Id2, which indicate the highest priority levels for those devices, are displayed.

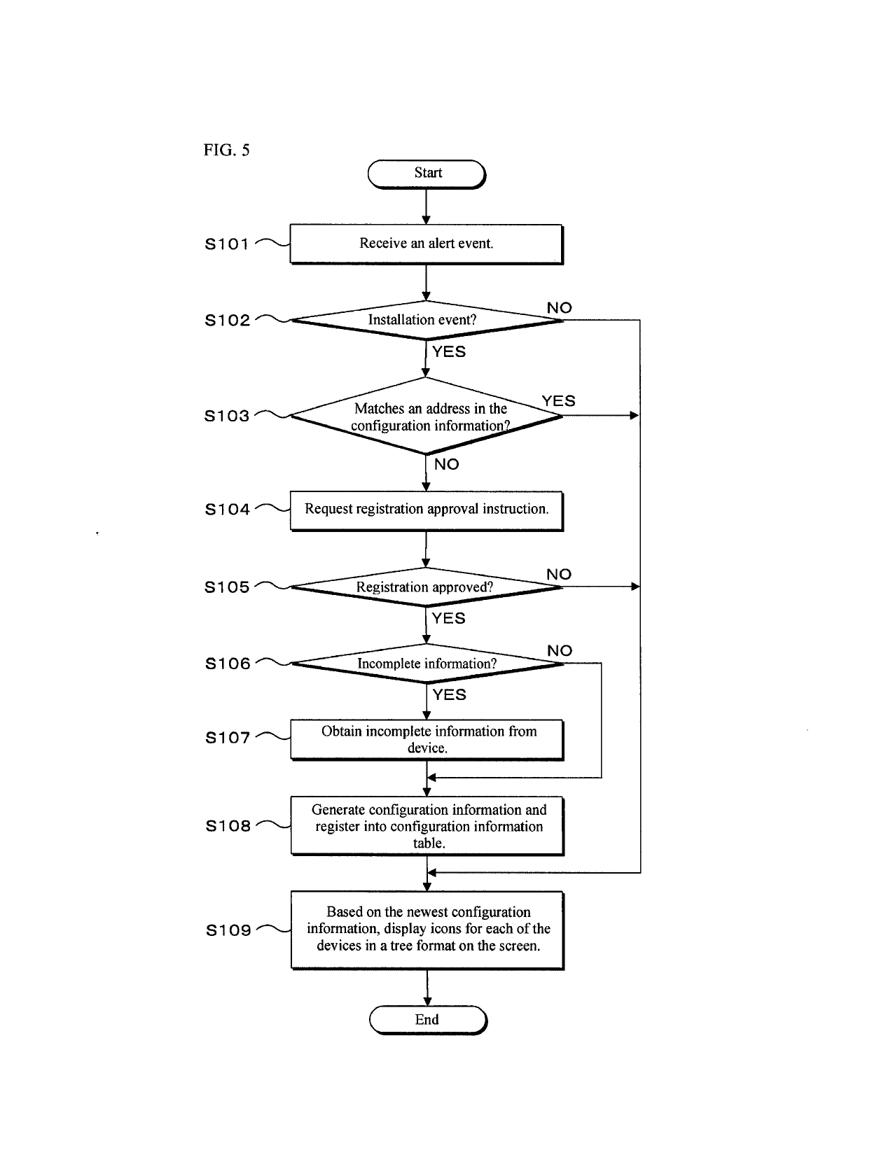

FIG. 5 is referenced next to explain the operation of the device manager 1 in the present example.

First, the receiving portion 11 receives an alert event that is produced by any of the devices (Step S101).

Following this, the evaluating portion 12 evaluates whether or not the alert event received in Step S101 is an installation event (Step S102). If the evaluation is NO (Step S102: NO), then processing advances to Step S109, described below.

On the other hand, if it is concluded in the evaluation in Step S102 that it is an installation event (Step S102: YES), then the evaluating portion 12 evaluates whether or not the address of the device that produced the alert event matches any of the addresses stored in the configuration information table 16a (Step S103). If the conclusion is YES (Step S103: YES), then processing advances to Step S109, described below.

On the other hand, if, in the evaluation in Step S103, the conclusion is that the address of the device does not match any of the addresses stored in the configuration information table 16a (Step S103: NO), then the registration instruction requesting portion 13 requests inputting of an instruction as to whether or not to register, into the system, the device that produced the alert event (Step S104).

Following this, if, in response to the request in Step S104, a registration approval instruction is received (Step S105: YES), then the configuration information registering portion 14 evaluates whether or not there is incomplete information that does not exist in the alert event received in Step S101 (Step S106). If the conclusion is NO (Step S106: NO), then processing advances to Step S108, described below.

On the other hand, if the conclusion in the evaluation in Step S106 is that there is incomplete information (Step S106: YES), then the configuration information registering portion 14 obtains that incomplete information from the device (Step S107).

Following this, the configuration information registering portion 14 generates configuration information based on the alert event received in Step S101 and/or the incomplete information obtained in Step S107, and registers, into the configuration information table 16a, the configuration information that has been generated (Step S108).

Following this, the displaying portion 15 displays, in a tree format on the screen, icons corresponding to the various devices, based on the configuration information stored in the most recent configuration information table 16a (Step S109). After this, processing returns to the main routine.

As described above, given the device manager 1 in the present example, the provision of the evaluating portion 12 makes it possible to evaluate whether or not an alert event is an installation event and possible to evaluate whether or not the address of a device that has produced an alert event matches any of the addresses stored in the configuration information table 16a. Moreover, the provision of the configuration information registering portion 14 makes it possible to generate configuration information for a device for which a connection is being added, to register that configuration information into the configuration information table 16a. Moreover, the provision of the displaying portion makes it possible to display icons corresponding to the various devices in a tree format on a screen based on the configuration information at that point in time.

This makes it possible to receive an installation event that is produced when a device is connected to a system and to generate, and register into the configuration information table 16a, configuration information for that device if the address of that device does not match any of the addresses stored in the configuration information table 16a, and possible to display on the screen, in a tree format, icons corresponding to the plurality of devices connected to the system, based on the configuration information after registration. Consequently this makes it possible to display icons, corresponding to the devices, onto the screen easily, even when a device is newly connected to the system.

Moreover, given the device manager 1 in the present example, the provision of the registration instruction requesting portion 13 makes it possible to request the administrator to input an instruction as to whether or not to register a device corresponding to an alert event when it is concluded by the evaluating portion 12 that the address of the device does not match any of the addresses that are stored in the configuration information table 16a.

Doing so makes it possible to register configuration information for a device that is newly connected only when registration is approved by the administrator, thus making it possible to prevent situations such as wherein configuration information is registered for a device that is connected in error, for example.

Moreover, given the device manager 1 in the present example, the configuration information registering portion 14, when generating configuration information, obtains, from the device, information that does not exist in the alert event, making it possible to eliminate the work by the administrator in supplementary inputting of the information that does not exist in the alert event.

Note that, in the functional structure of the device manager 1, in the example set forth above, the registration instruction requesting portion 13 can be omitted. If the registration instruction requesting portion 13 is omitted, then in the event that there is a conclusion by the evaluating portion 12 that the address of a device does not match any of the addresses stored in the configuration information table 16a, the configuration information registering portion 14 may generate the configuration information based on the alert event received from the receiving portion 11 to register it into the configuration information table 16a.

While in the example set forth above a device that has a function for two-way communication with a controller through a Fieldbus was used as an example of the device 3, the devices to which the present invention can be applied are not limited thereto. For example, a device that includes an HART (Highway Addressable Remote Transducer) communication function (hereinafter termed a “HART communication-compatible device”) may be used as the device 3. As with the example set forth above, installation/removal events may be sent to the device manager 1 in accordance with the installation/removal status of the HART communication-compatible device.

We claim:

1. A device manager displaying on a screen, in a tree format, respective indicators corresponding to a plurality of devices managed in a hierarchical structure, comprising:
a storing portion storing, for each device, configuration information pertaining to the configuration of that device;
a receiving portion receiving an alert event produced by one of the devices;
an evaluating portion evaluating whether or not an address of a device matches any of the addresses included in the configuration information that is stored in the storing portion if the alert event received by the receiving portion is an installation event that is generated when a device is connected to the system;
a configuration information registering portion generating, and storing into the storing portion, configuration information based on the alert event received by the receiving portion if the conclusion by the evaluating portion is that the address of the device does not match any of the addresses included in the configuration information; and
a displaying portion displaying said indicators on said screen based on the configuration information stored in the storing portion.

2. The device manager as set forth in claim 1, further comprising:
a registration instruction requesting portion requesting inputting of an instruction as to whether or not to register the device corresponding to the alert event when there is a conclusion by the evaluating portion that the address of the device does not match any of the addresses included in the configuration information;
wherein the configuration information registering portion generates, and stores in the storing portion, configuration information when an instruction indicating that the device is to be registered is received in response to a request by the registration instruction requesting portion.

3. The device manager as set forth in claim 1, wherein:
when generating configuration information, the configuration information registering portion obtains, from the device, information that is not included in the alert event.

4. A device managing method for displaying on a screen, in a tree format, respective indicators corresponding to a plurality of devices managed in a hierarchical structure, comprising:
a receiving step receiving an alert event produced by one of the devices;
an evaluating step evaluating whether or not an address of a device matches any of the addresses included in the configuration information that is stored in a storing portion, which stores, for each of the devices, configuration information pertaining to the configuration of that device, if the alert event received in the receiving step is an installation event that is generated when a device is connected to the system;
a configuration information registering step generating, and storing into the storing portion, configuration information based on the alert event received in the receiving step if the conclusion is the evaluating step is that the address of the device does not match any of the addresses included in the configuration information; and
a displaying step displaying said indicators on said screen based on the configuration information registered in the storing portion.
